(19) United States
(12) Patent Application Publication
(10) Pub. No.: US 2017/0011147 A1
(43) Pub. Date: Jan. 12, 2017

(54) SIMULATION DEVICE, SIMULATION PROGRAM AND SIMULATION METHOD FOR LIQUID METAL

(71) Applicant: FUJITSU LIMITED, Kawasaki-shi (JP)

(72) Inventor: Masaki KAZAMA, Kawasaki (JP)

(73) Assignee: FUJITSU LIMITED, Kawasaki-shi (JP)

(21) Appl. No.: 15/185,070

(22) Filed: Jun. 17, 2016

(30) Foreign Application Priority Data
Jul. 10, 2015 (JP) 2015-139125

(51) Int. Cl. G06F 17/50

(52) U.S. Cl. CPC G06F 17/5009

(57) ABSTRACT

A simulation method, a simulation program and a simulation device are disclosed. The simulation method is for causing a computer to execute a process, the process includes: causing the computer to acquire a relationship between a viscosity and a Young's modulus of a material and internal energy; causing the computer to acquire an initial value of each of a position, a density, a velocity, and an internal energy of each particle obtained by modeling a calculation target that uses the material; and calculating the position, the density, the velocity, and the internal energy of the each particle after a predetermined time has elapsed, based on a corrected viscosity obtained by correcting the viscosity using the acquired internal energy and the viscosity and Young's modulus acquired using the acquired relationship.

### CROSS-REFERENCE TO RELATED APPLICATION

This application is based upon and claims the benefit of priority of the prior Japanese Patent Application No. 2015-139125, filed on Jul. 10, 2015, the entire contents of which are incorporated herein by reference.

### FIELD

The embodiments discussed herein are related to a simulation device, a simulation program, and a simulation method for liquid metal, such as molten metal and the like, used in die casting.

### BACKGROUND

Casting in which molten metal is poured into a casting mold and thus solidified to produce a cast product has been used. A simulation method in which a flow process in which molten metal flows and a solidifying process in which the molten metal is cooled down and solidified are calculated using a smoothed particle hydrodynamics (SPH) method is described, for example, in Paul W. Cleary, Extension of SPH to predict feeding, freezing, and defect creation in low pressure die casting, Applied Mathematical Modelling, 2010, Vol. 34, pp. 3189-3201.

A method in which, for a part of metal which has been solidified in the casting mold, analysis is performed using a rigid body motion equation to reduce a simulation time is described in, for example, Japanese Laid-open Patent Publication No. 2014-146302. A simulation method considering effects of radiation cooling of molten metal is described, for example, in Japanese Laid-open Patent Publication No. 2014-211798.

A simulation method in which motion of an elastic body is simulated using the Young's modulus is described, for example, in Yoichi Kawashima and Yuzuru Sakai, Large Deformation Analysis of Hyperelastic Materials Using SPH method, e-Journal of Soft Materials, 2007, Vol. 3, pp. 21-28.

In accordance with the methods described in Paul W. Cleary, Extension of SPH to predict feeding, freezing, and defect creation in low pressure die casting, Applied Mathematical Modelling, 2010, Vol. 34, pp. 3189-3201, and Japanese Laid-open Patent Publication No. 2014-211798, it is not possible to perform a simulation considering that the Young's modulus changes when molten metal is solidified. In Japanese Laid-open Patent Publication No. 2014-146302, calculation is performed separately for metal in a liquid state and metal in a solid state, and therefore, a simulation considering that the Young's modulus changes in an intermediated state between the liquid state and the solid state may not be performed. Therefore, if the above-described methods are used, accuracy of simulations of, for example, a position in which a flow of molten metal stops in a casting mold and a phenomenon, such as generation of a recess in a surface of a cast product and the like, is low.

In the method described in Yoichi Kawashima and Yuzuru Sakai, Large Deformation Analysis of Hyperelastic Materials Using SPH method, e-Journal of Soft Materials, 2007, Vol. 3, pp. 21-28, in consideration of an influence of the Young's modulus, calculation is performed at short time intervals. Therefore, a calculation amount for performing a simulation is increased.

### SUMMARY

According to an aspect of the invention, a simulation method is disclosed. The simulation method is for causing a computer to execute a process, the process includes: causing the computer to acquire a relationship between a viscosity and a Young's modulus of a material and internal energy; causing the computer to acquire an initial value of each of a position, a density, a velocity, and an internal energy of each particle obtained by modeling a calculation target that uses the material; and calculating the position, the density, the velocity, and the internal energy of the each particle after a predetermined time has elapsed, based on a corrected viscosity obtained by correcting the viscosity using the acquired internal energy and the viscosity and Young's modulus acquired using the acquired relationship.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of a simulation device;

FIGS. 2A and 2B are graphs illustrating temperature dependence of viscosity and Young's modulus of an alloy;

FIG. 3 is a diagram illustrating particle behavior;

FIG. 4 is a table illustrating a record layout of a physical property DB;

FIG. 5 is a table illustrating a record layout of a particle DB;

FIG. 6 is a flow chart illustrating a flow of processing of a simulation program;

FIG. 7 is a flow chart illustrating a flow of processing of a subroutine in which x, v, u, and ρ for n+1 are calculated;

FIG. 8 is a graph illustrating change in weight function;

FIG. 9 is a table illustrating a record layout of a basic physical property DB according to a second embodiment;

FIG. 10 is a flow chart illustrating a flow of processing of a program according to the second embodiment;

FIG. 11 is a functional block diagram illustrating an operation of a simulation device according to a third embodiment; and

FIG. 12 is a diagram illustrating a configuration of a simulation device according to a fourth embodiment.

### DESCRIPTION OF EMBODIMENTS

### First Embodiment

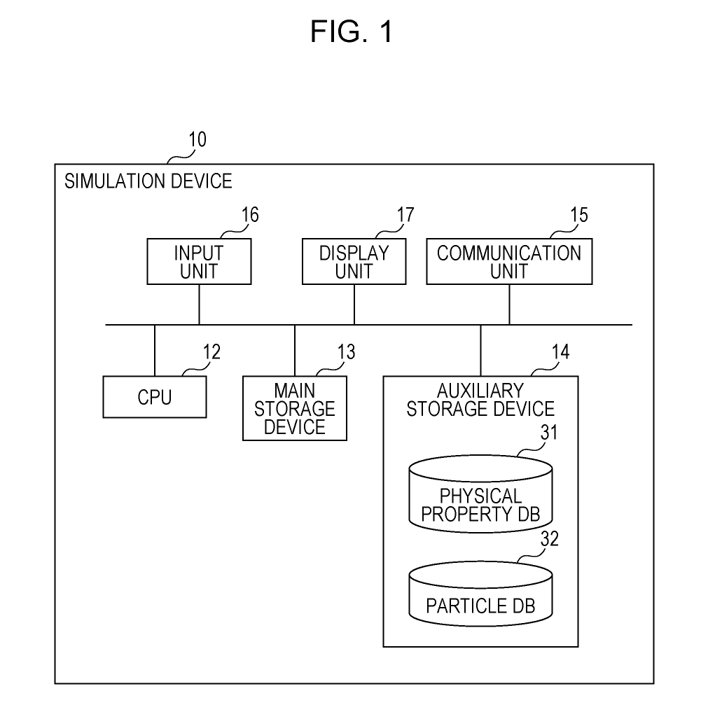

FIG. 1 is a diagram illustrating a configuration of a simulation device 10. The simulation device 10 includes a central processing unit (CPU) 12, a main storage device 13, an auxiliary storage device 14, a communication unit 15, an input unit 16, a display unit 17, and a bus. The simulation device 10 according to this embodiment uses an information device, such as a general-purpose personal computer, a tablet, and the like.

The CPU 12 is an arithmetic and control unit that executes a program according to this embodiment. As the CPU 12, one or more CPUs, multi-core CPUs, or the like are used. The CPU 12 is coupled to each of hardware components that form the simulation device 10 via the bus. The CPU 12 may be a MPU (Microprocessor Unit) or any other kind of processor.

The main storage device 13 is a storage device or a memory, such as a static random access memory (SRAM), a dynamic random access memory (DRAM), a flash memory, and the like. Information used while processing is performed by the CPU 12 and a program that is being executed by the CPU 12 are temporarily stored in the main storage device 13.

The auxiliary storage device 14 is also a storage device or a memory, such as an SRAM, a flash memory, a hard disk, a magnetic tape, and the like. A program that is executed by the CPU 12, and various types of information, such as a physical property DB 31, a particle DB 32, and the like, which are used in execution of the program, are stored in the auxiliary storage device 14.

The communication unit 15 is an interface that performs communication with a network, such as the Internet, an intranet, and the like, which is not illustrated in FIG. 1.

The input unit 16 is a device, such as a mouse, a keyboard, a touch panel, a pen tablet, a microphone, and the like, and is used when the simulation device 10 receives an operation input by a user. The display unit 17 is a device, such as a display, a printer, a plotter, and the like, and displays a simulation result and the like.

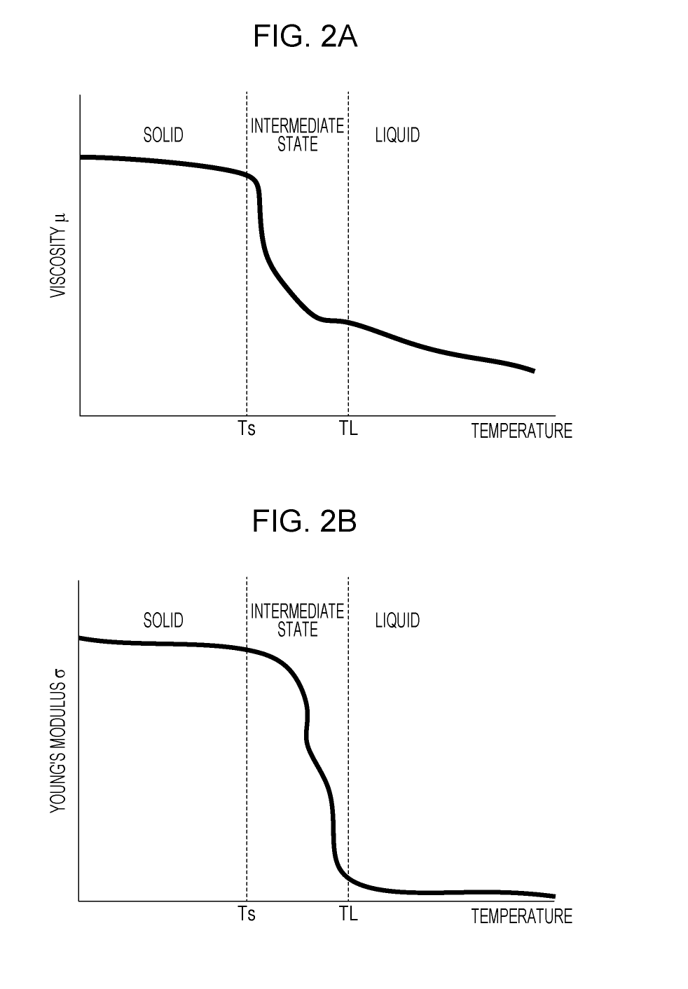

FIGS. 2A and 2B are graphs illustrating the temperature dependence of the viscosity μ and the Young's modulus σ of an alloy. In the simulation device 10 according to this embodiment, for example, molten metal is poured into a casting mold, and thus, solidified, and then, the solidified metal is used for a simulation of a process of producing a cast product. As a material of the cast product, an alloy, such as an aluminum alloy, a copper alloy, a zinc alloy, a magnesium alloy, a ferro-alloy, and the like, is used. An aluminum alloy is an alloy obtained by adding a small amount of silicon, magnesium, copper, and the like to aluminum, which is a principal component. Similarly, each of the other alloys described above, such as a copper alloy and the like, is an alloy obtained by adding a small amount of chemical elements to a principal component and is a material that has a property suitable for casting.

FIG. 2A is a graph illustrating the temperature dependence of the viscosity μ of an alloy used for casting. In FIG. 2A, the abscissa axis indicates temperature, and the ordinate axis indicates the viscosity μ. FIG. 2B is a graph illustrating the dependence of the Young's modulus σ of the alloy used for casting. In FIG. 2B, the abscissa axis indicates temperature, and the ordinate axis indicates the Young's modulus σ. Each of respective numerical values of the ordinate axis and the abscissa axis varies depending on components of the alloy.

The viscosity μ and the Young's modulus σ will be described below. The viscosity μ is a value that represents the magnitude of viscosity. Viscosity is force that causes the velocity of a flow in a fluid to be uniform. The unit of the viscosity μ is Pascal second. The Young's modulus σ is a value that represents the ratio between a tensile stress or a compressive stress and a deformation caused by the stress. The unit of the Young's modulus σ is Pascal. Each of the viscosity μ and the Young's modulus σ varies depending on a material. Each of the viscosity μ and the Young's modulus σ may be measured by an experiment. There are also cases where, as principal properties of a material, the viscosity μ and the Young's modulus σ of the material are provided by a material supplier, a public organization, or the like.

An alloy is solid at a low temperature, and is liquid at high temperature. An alloy reversibly changes between a liquid state and a solid state in accordance with temperature. As for a pure substance, clear phase transition between a solid state and a liquid state occurs at the melting point thereof serving as a boundary, and the viscosity μ and the Young's modulus σ rapidly change as well. However, as for an alloy containing a plurality of chemical elements mixed therein, as illustrated in FIGS. 2A and 2B, there is an intermediate state interposed between solidus temperature Ts and liquidus temperature TL. The alloy is solid at lower temperature than the solidus temperature Ts, and is liquid at higher temperature than the liquidus temperature TL.

For the solid alloy, each of the viscosity μ and the Young's module σ is a large value. On the other hand, for the liquid alloy, the viscosity μ is a small value, and the Young's module σ is substantially zero. At temperature between the solidus temperature Ts and the liquidus temperature TL, each of the viscosity μ and the Young's module σ is a value between values thereof in a solid state and a liquid state.

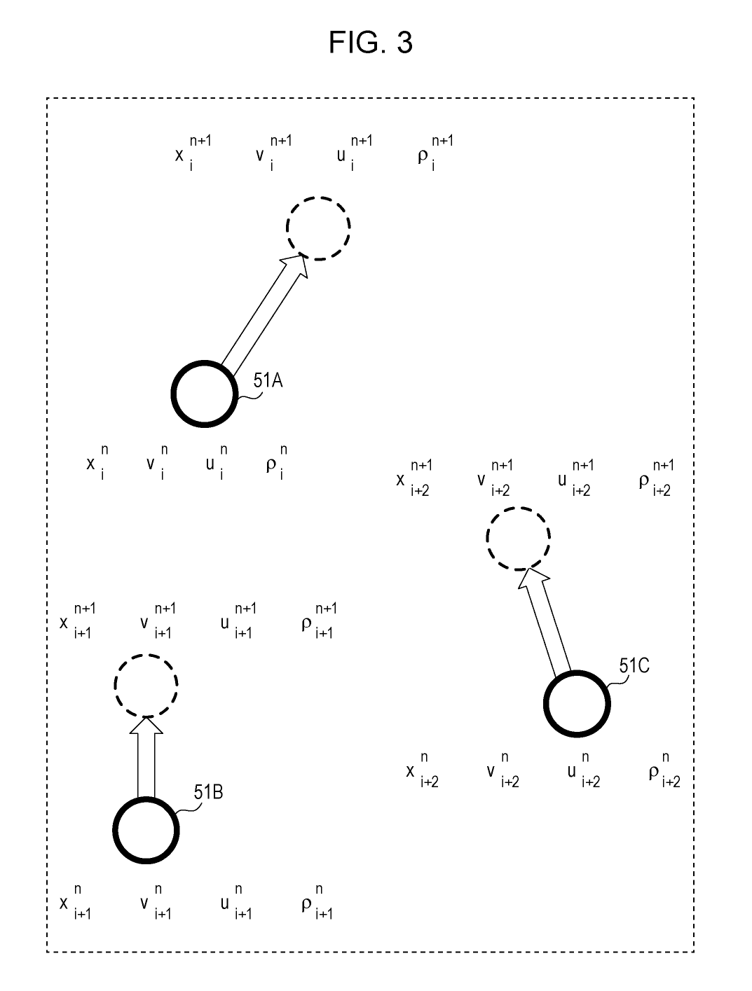

FIG. 3 is a diagram illustrating particle behavior. A model of a simulation that is used in this embodiment will be described with reference to FIG. 3. In this embodiment, an SPH method is used. The SPH method is a type of simulation method in which the behavior of a continuum is analyzed, and is suitable for fluid analysis.

A particle 51A, a particle 51B, and a particle 51C indicate model particles obtained by modeling an alloy that is a simulation target. When the particle 51A, the particle 51B, and the particle 51C are described without being distinguished from one another, the particle 51A, the particle 51B, and the particle 51C are described as particles 51. When a behavior in casting a single cast product is simulated, several hundred thousand to several million particles 51 are used. The particle 51A is an ith particle, the particle 51B is an (i+1)th particle, and the particle 51C is an (i+2)th particle.

The state of each particle 51 is represented by a position x, a velocity v, an internal energy u, and a density ρ. The position x is a coordinate that indicates the position of the particle 51 and a vector including three elements. The velocity v is a vector that indicates the velocity of the particle 51 relative to the direction of each coordinate axis and includes three elements. The internal energy u is a scalar quantity that indicates the amount of energy included in the particle 51. The density ρ is a scalar quantity that indicates the density of the particle 51. In the description below, a numerical subscript indicates the number of the particle 51, and a numerical superscript indicates the number of times a calculation has been performed. For example, the position vector xᵢⁿ indicates the position vector of the ith particle 51A, which was obtained by an nth calculation. Also, there are cases, when the number of the particle 51 and the number of times a calculation has been performed are clear, and when the number of the particle 51 and the number of times a calculation has been performed are not desired to be distinguished, the numerical subscript and superscript will be omitted.

Values to which the position vector xᵢⁿ, the velocity vᵢⁿ, the internal energy uᵢⁿ, and the density ρᵢⁿ of the particle 51A, which were obtained by the nth calculation, change after a step time dt has elapsed are calculated. Results of the calculation are the position vector xᵢⁿ⁺¹, the velocity vᵢⁿ⁺¹, the internal energy uᵢⁿ⁺¹, and the density ρᵢⁿ⁺¹. A calculation method will be described later. This calculation is repeated for all of the particles 51 until a predetermined condition is satisfied, thereby simulating a behavior in casting a cast product. The predetermined condition is, for example, that the internal energy μ of each of all of the particles 51 is equal to or less than a threshold, or that the calculation has been completed a predetermined number of times.

An appropriate step time dt is determined in accordance with a target model that is simulated. If the step time dt is too large, the accuracy of the simulation is reduced. Also, depending on a condition, results disperse and a simulation may not be completed normally. On the other hand, if the step time dt is too small, it takes an increased time to perform a simulation. In this embodiment, 1 microsecond is used for the step time dt.

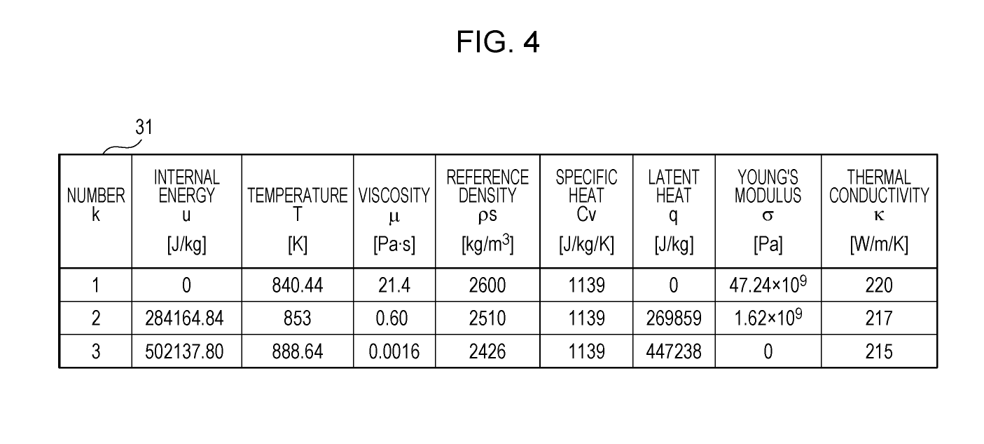

FIG. 4 is a table illustrating a record layout of a physical property DB 31. The physical property DB 31 is a DB that associates the internal energy u, the temperature T, and the physical property of a specific material with one another. The physical property DB 31 includes a number k field, an internal energy u field, a temperature T field, a viscosity μ field, a reference density ρs field, a specific heat Cv field, a latent heat q field, a Young's modulus σ field, and a thermal conductivity κ field. The physical property DB 31 includes a single record for the value of a single internal energy u.

In the number k field, serial numbers of physical property records are recorded consecutively. The physical property records are arranged in an ascending order in which values were recorded in the internal energy u field. In the internal energy u field, the internal energy u of a material of 1 kg is recorded. The internal energy u is a relative value of energy of the material, assuming a predetermined state as a reference. The unit of the internal energy u is joule per kilogram. In the temperature T field, the temperature T corresponding to the value of the internal energy u is recorded. The unit of the temperature T is Kelvin. In the viscosity μ field, the viscosity μ corresponding to the value of the internal energy u is recorded. As described above, the viscosity μ is viscosity, that is, the magnitude of force that causes the velocity of a flow in a fluid to be uniform. The unit of the viscosity μ is Pascal second. In the reference density ρs field, the reference density ρs of the material, corresponding to the value of the internal energy u is recorded. The reference density ρs is the density of the material when an external pressure is not applied. The unit of the reference density ρs is cubic meters per kilogram.

In the specific heat Cv field, the specific heat Cv corresponding to the value of the internal energy u is recorded. The specific heat is the amount of energy used for raising the temperature T of the material of 1 kilogram by 1 Kelvin. The unit of the specific heat is joule per kilogram Kelvin. In the latent heat q field, the latent heat q corresponding to the value of the internal energy u is recorded. The latent heat q is the amount of energy used for phase change of the material in changing the state of the material of 1 kilogram from 0 Kelvin to a state corresponding to the internal energy u. The phase change is, for example, change of the state of the material from a solid state to a liquid state. The unit of the latent heat q is joule per kilogram.

In the Young's modulus σ field, the Young's modulus σ corresponding to the value of the internal energy u is recorded. As described above, the Young's modulus σ is a value that indicates the ratio between a tensile stress or a compressive stress and a deformation caused by the stress. The unit of the Young's modulus σ is Pascal. In the thermal conductivity κ field, the thermal conductivity κ corresponding to the value of the internal energy u is recorded. The thermal conductivity κ indicates the magnitude of a heat flux that is, when there is a temperature gradient in the material, carried along the gradient. The unit of the thermal conductivity κ is watt per meter Kelvin. The heat flux is the amount of heat across a unit area in a unit time. The unit of the heat flux is watt per square meter.

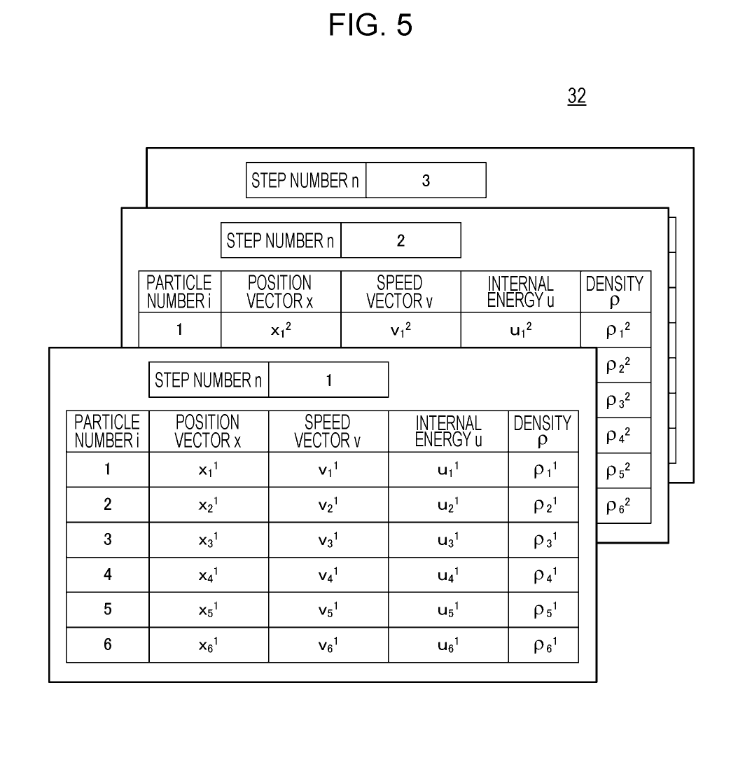

FIG. 5 is a table illustrating a record layout of a particle DB 32. The particle DB 32 is a DB that associates the number of the model particle 51, obtained by modeling an alloy that is a simulation target, the calculated step number, and the state of the particle with one another. The particle DB 32 includes a step number n field, a particle number i field, a position vector x field, a velocity v field, an internal energy u field, and a density ρ field.

In the step number n field, the step number n, which is the number of times the calculation has been repeated to obtain a result, is recorded. In the particle number i field, the number of the particle 51 is recorded. In the position vector x field, the position vector xᵢⁿ of the particle corresponding to the step number n and the particle number i is recorded. In the velocity v field, the velocity vᵢⁿ of the particle corresponding to the step number n and the particle number i is recorded. In the internal energy u field, the internal energy uᵢⁿ of the particle corresponding to the step number n and the particle number i is recorded. In the density ρ field, the density ρᵢⁿ of the particle corresponding to the step number n and the particle number i is recorded.

In each particle record when the step number n is 1, an initial condition of a simulation is recorded. In each particle record when the step number n is 2, the state of each particle after the step time dt has elapsed, which has been obtained by performing one cycle of simulation according to this embodiment, is recorded. Thereafter, in each particle record when the step number n is n, the state of each particle after a time corresponding to the product of the step time dt and n is recorded.

A simulation result of the flow state of liquid metal in producing a cast product may be visualized, for example, by visualizing change in velocity vᵢⁿ with time for each step number n, based on the particle DB 32. Also, a simulation result of a recess in a surface of a cast product and an internal cavity may be visualized by visualizing the distribution of the position vector xᵢⁿ at the time when a simulation is completed.

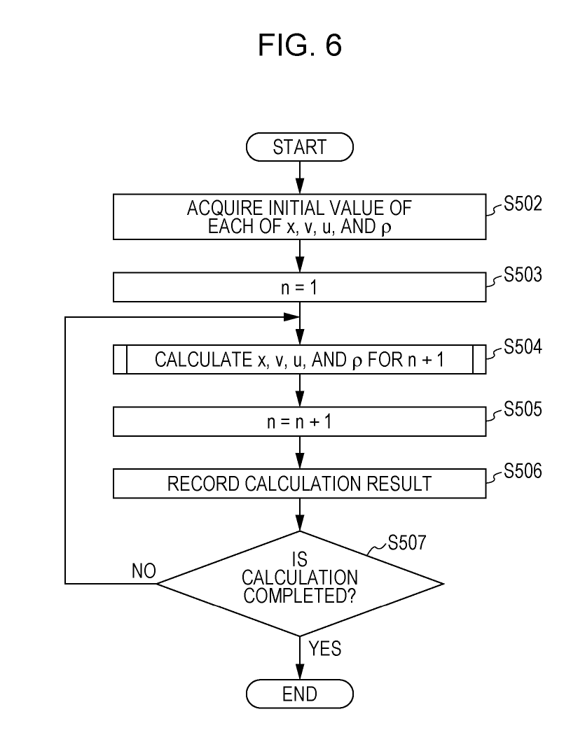

FIG. 6 is a flow chart illustrating a flow of processing of a simulation program. A flow of processing of a simulation program according to this embodiment will be described with reference to FIG. 6.

The CPU 12 acquires, from the particle DB 32, an initial value of each of the position vector x, the velocity v, the internal energy u, and the density ρ of a model that is simulated (Step S502). As described above, the initial value is recorded in a record of the particle DB 32, in which 1 is indicated in the step number n field.

The CPU 12 sets the step number n to 1 (Step S503). The CPU 12 starts up a subroutine in which x, v, u, and ρ for n+1 are calculated (Step S504). The subroutine in which x, v, u, and ρ for n+1 are calculated is a subroutine in which the position vector x, the velocity v, the internal energy u, and the density ρ after the step time dt has elapsed are calculated. A flow of processing of the subroutine in which x, v, u, and ρ for n+1 are calculated will be described later.

The CPU 12 adds 1 to n (Step S505). The CPU 12 adds a record to the particle DB 32 to record a calculation result obtained by the subroutine in which x, v, u, and ρ for each of the step numbers n and n+1 are calculated (Step S506).

The CPU 12 determines whether or not the calculation is completed (Step S507). For example, if the internal energy u of each of all of the particles 51 is equal to or lower than a threshold, if the calculation has been completed a predetermined number of times, or if like predetermined condition is satisfied, the CPU 12 determines that the calculation is completed. If the CPU 12 determines that the calculation is completed (YES in Step S507), the CPU 12 terminates processing. If the CPU 12 determines that the calculation is not completed (NO in Step S507), the CPU 12 causes the process to return to Step S504.

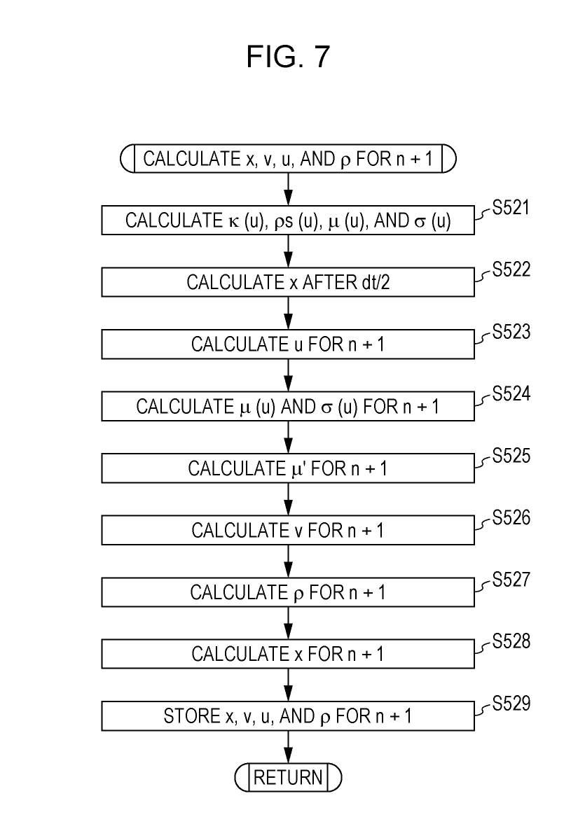

FIG. 7 is a flow chart illustrating a flow of processing of the subroutine in which x, v, u, and ρ for n+1 are calculated. The subroutine in which x, v, u, and ρ for n+1 are calculated is a subroutine in which the position vector x, the velocity v, the internal energy u, and the density ρ after the step time dt has elapsed are calculated. A flow of processing of the subroutine in which x, v, u, and ρ for n+1 are calculated will be described with reference to FIG. 7.

The CPU 12 refers to the physical property DB 31, and calculates the heat conductivity κ (u), the reference density ρs (u), the viscosity μ (u), and the Young's modulus σ (u) of each particle 51, which correspond to the internal energy u obtained by the nth calculation (Step S521). Specifically, the CPU 12 searches in the internal energy u field of the physical property DB 31 using, as a key, the internal energy uᵢⁿ of the ith particle 51. If there is a record that matches the internal energy uᵢⁿ, the heat conductivity κ, the reference density ρs, the viscosity μ, and the Young's modulus σ which are recorded in the record are substituted in the heat conductivity κ (uᵢⁿ), the reference density ρs (uᵢⁿ), the viscosity μ (uᵢⁿ), and the Young's modulus σ (uᵢⁿ) which correspond to the internal energy uᵢⁿ. If there is not a record that matches the internal energy (uᵢⁿ), the heat conductivity κ (uᵢⁿ), the reference density ρs (uᵢⁿ), the viscosity μ (uᵢⁿ), and the Young's modulus σ (uᵢⁿ) which correspond to the internal energy uᵢⁿ is calculated by interpolation, using a record in which the proximity internal energy u is recorded. Linear interpolation and another arbitrary interpolation method may be used for the interpolation.

The CPU 12 calculates the position vector x of each particle 51 after the half of the step time dt has elapsed, based on Expression 1 (Step S522).

$${x}_{i}^{n + 1 / 2} = {x}_{i}^{n} + \frac{d t}{2} {v}_{i}^{n} \qquad ( 1 )$$

where dt is the step time,
xᵢⁿ is the position vector of the ith particle at the nth time,

xᵢ^{n+1/2} is the position vector of the ith particle after

$$\frac{d t}{2}$$

has elapsed since the nth time, and
vᵢⁿ is the velocity of the ith particle at the nth time.

Note that the same symbol is used to indicate the same parameter in expressions described below. Therefore, the description of a symbol that has been described once will be omitted when the symbol appears second and subsequent times.

The CPU 12 calculates the internal energy u of each particle 51 at an (n+1)th time, based on Expression 2 obtained by discretizing an energy conservation law (Step S523). In Expression 2, the (n+1)th time is a time after the step time dt has elapsed since the nth time.

$${u}_{i}^{n + 1} = {u}_{i}^{n} + d t {\sum }_{j}^{ } \frac{4 {m}_{j}}{{ρ}_{i}^{n} {ρ}_{j}^{n}} \frac{κ ( {u}_{i}^{n} ) κ ( {u}_{j}^{n} )}{κ ( {u}_{i}^{n} ) + κ ( {u}_{j}^{n} )} ( T ( {u}_{i}^{n} ) - T ( {u}_{j}^{n} ) ) \cdot \frac{\partial W ( \vert {x}_{ij}^{n + 1 / 2} \vert )}{\partial {x}_{i}^{n + 1 / 2}} + {Q}_{i} \qquad ( 2 )$$

where uᵢⁿ is the internal energy the ith particle at the nth time,
mⱼ is the mass of the ith particle,
ρᵢⁿ is the density of the ith particle at the nth time,
κ (u) is the thermal conductivity when the internal energy is u,
T (u) is the temperature when the internal energy is u,
W (r, h) is a weight function,
xᵢⱼⁿ=xᵢⁿ−xᵢⁿ is the relative position vector between the ith particle and the jth particle at the nth time,
h is the radius of influence of the particle, and
Qᵢ is the amount of heat that externally flows in.

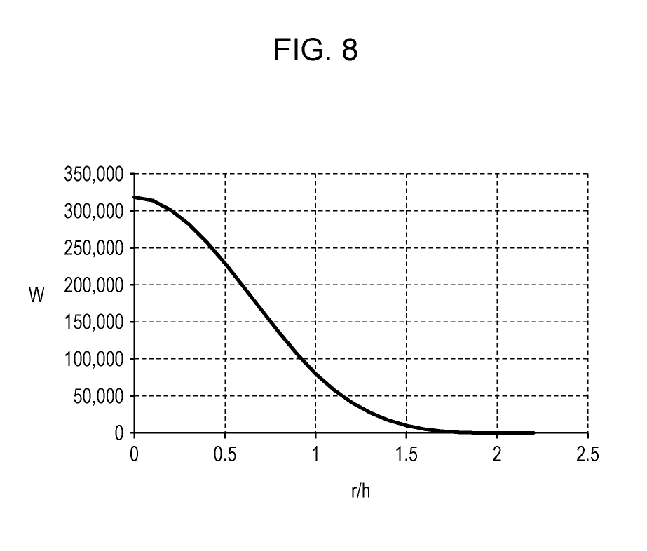

A weight function W is a function with which weighting of the degree of the influence of the particles 51 that exist in different positions apart from one another is performed. In this embodiment, a spline function indicated in Expression 3 is used for the weight function. FIG. 8 is a graph illustrating change in weight function.

$$W ( r , h ) = \{ \begin{matrix}( 1 - 1.5 {( \frac{r}{h} )}^{2} + 0.75 {( \frac{r}{h} )}^{3} ) / β & 0 \leq \frac{r}{h} < 1 , \\ 0.25 {( 2 - \frac{r}{h} )}^{3} / β & 1 \leq \frac{r}{h} < 2 , \\ 0 & 2 \leq \frac{r}{h}\end{matrix} . \qquad ( 3 )$$

where r is a parameter of the weight function W, and
β is a constant.

The radius h of influence of the particle is a constant of a value equal to the double to the triple of an average particle interval in an initial state. The constant β is a value used for adjusting the total space integrated value of the weight function W to 1, when a three-dimensional simulation is performed, the constant β is πh³, and when a two-dimensional simulation is performed, the constant β is 0.7πh². In this case, π indicates a circular constant. In FIG. 8, W when a three-dimensional simulation is performed is indicated.

Note that the weight function W is not limited to the spline function indicated in Expression 3. An arbitrary function W(r) that satisfies Expression 4 may be used for the function W.

∫W(r)dr=1 (4)

The CPU 12 calculates the viscosity μ (u) and the Young's modulus σ (u) that correspond to the internal energy u of each particle 51 at the (n+1)th time that has been calculated in Step S523 (Step S524). The calculation method used in Step S524 is the same as that used in Step S521.

The CPU 12 calculates a corrected viscosity μ′ of each particle at the (n+1)th time, based on Expression 5 (Step S525).

$${μ}_{i}^{′n + 1} = μ ( {u}_{i}^{n + 1} ) + σ ( {u}_{i}^{n + 1} ) \times \frac{A}{{C}_{0}} \qquad ( 5 )$$

where A is the diameter of the particle 51, and
C₀ is a constant.

Note that the value of A described above may be set by a user of this simulation device in accordance with a minimal scale, such as, for example, the dimension of the smallest gap of the casting mold and the like, which is desired to be analyzed.

The corrected viscosity μ′ is a value obtained by adding an influence of the Young's modulus σ to the viscosity μ. In this embodiment, 1000 is used for the constant C₀.

The corrected viscosity μ′ will be described. In this embodiment, instead of the viscosity μ, the corrected viscosity μ′ is used, and thus, a simulation considering the influence of the Young's modulus σ in a pseudo manner.

That is, a value obtained by integrating the Young's modulus σ and the constant A/C₀ is added to the viscosity μ of the material, which has been increased as the molten metal was cooled down, so that an influence of change in the Young's modulus a, which has been described with reference to FIG. 2, may be reflected to a simulation result. A method in which the corrected viscosity μ′ is used will be described later.

The CPU 12 calculates the velocity v of each particle at the (n+1)th time, based on Expression 6, which was obtained by discretizing a momentum conservation law (Step S526).

$${v}_{i}^{n + 1} = {v}_{i}^{n} - 2 d t {\sum }_{j}^{ } {m}_{j} ( \frac{{p}_{ij}^{n}}{{ρ}_{j}^{n} {ρ}_{i}^{n}} - {Π}_{ij}^{n + 1 , *} ) \frac{{x}_{ij}^{n + 1 / 2}}{\vert {x}_{ij}^{n + 1 / 2} \vert} \frac{\partial W ( \vert {x}_{ij}^{n + 1 / 2} \vert , h )}{\partial {x}_{i}^{n + 1 / 2}} \qquad ( 6 )$$

where pᵢⱼⁿ is the average pressure between the ith particle and jth particle at the nth time, and
Πᵢⱼⁿ⁺¹ is a viscosity stress coefficient that is determined by the ith particle and the jth particle at the (n+1)th time.

The definition of an average pressure p in Expression 6 is indicated in Expression 7.

$${p}_{ij}^{n} = \frac{( {p}_{i}^{n} - {p}_{i}^{n} )}{2} \qquad ( 7 )$$

where pᵢⁿ is the pressure of the ith particle at the nth time.

The pressure p in Expression 7 may be obtained, based on Expression 8.

pᵢⁿ=c^{z}(ρⱼⁿ−ρₛ(uₗⁿ)) (8)
where c is the velocity of sound in the material, and
ρₛ (u) is the reference density when the internal energy is u.

Then, Π in Expression 6 will be described. When the momentum conservation law is discretized, Π in Expression 6 is defined as in Expression 9.

$${Π}_{ij}^{n + 1} = \frac{4 {m}_{j}}{{ρ}_{i}^{n} {ρ}_{j}^{n}} \frac{{μ}_{i}^{n + 1} {μ}_{j}^{n + 1}}{{μ}_{i}^{n + 1} + {μ}_{j}^{n + 1}} ( {v}_{i}^{n + 1} - {v}_{j}^{n + 1} ) \frac{{x}_{ij}^{n + \frac{1}{2}}}{\vert {x}_{ij}^{n + \frac{1}{2}} \vert} \qquad ( 9 )$$

In order to take the influence of the Young's modulus σ into account, the viscosity μ in Expression 9 is replaced with the corrected viscosity μ′, which has been described above, and thus, Expression 10 may be obtained.

$${Π}_{ij}^{n + 1} = \frac{4 {m}_{j}}{{ρ}_{i}^{n} {ρ}_{j}^{n}} \frac{{μ}_{i}^{′n + 1} {μ}_{j}^{′n + 1}}{{μ}_{i}^{′n + 1} + {μ}_{j}^{′n + 1}} ( {v}_{i}^{n + 1} - {v}_{j}^{n + 1} ) \frac{{x}_{ij}^{n + \frac{1}{2}}}{\vert {x}_{ij}^{n + \frac{1}{2}} \vert} \qquad ( 10 )$$

Expression 10 and Expression 5 are substituted in Π in Expression 6, and thus, a simulation considering the influence of the Young's modulus σ may be performed.

Returning to Expression 6, a method for calculating the velocity v of each particle at the (n+1)th time will be described. Expression 7, Expression 8, and Expression 10 are substituted in Expression 6, and thus, simultaneous linear equations in which the velocity v of each particle at the (n+1)th time is an unknown may be obtained. The simultaneous linear equations are solved using an algorithm, such as a conjugate gradient method and the like, and thus, the velocity v of each particle at the (n+1)th time may be obtained. The algorithm used herein to solve the simultaneous linear equations is an algorithm that has been conventionally used, and therefore, the description thereof will be omitted.

The CPU 12 calculates the density ρ of each particle 51 at the (n+1)th time, based on Expression 11 obtained by discretizing a mass conservation law (Step S527).

$${ρ}_{i}^{n + 1} = {ρ}_{i}^{n} + 2 d t {\sum }_{j}^{ } {m}_{j} \frac{{ρ}_{i}}{{ρ}_{j}} ( {v}_{i}^{n + 1} - {v}_{j}^{n + 1} ) \cdot \frac{\partial }{\partial {x}_{ij}^{n + 1 / 2}} W ( \vert {x}_{ij}^{n + 1 / 2} \vert , h ) \qquad ( 11 )$$

The CPU 12 calculates the position vector x of each particle 51 at the (n+1)th time, based on Expression 12 (Step S528).

$${x}_{i}^{n + 1} = {x}_{i}^{n + 1 / 2} + \frac{d t}{2} {v}_{i}^{n + 1} \qquad ( 12 )$$

The CPU 12 stores the position vector x, the velocity v, the internal energy u, and the density ρ of each particle 51 at the (n+1)th time in the auxiliary storage device 14 (Step S529). Thereafter, the CPU 12 terminates processing.

According to this embodiment, a highly accurate simulation considering the influence of the Young's modulus σ may be performed with a small calculation amount.

The calculation amount will be described. A reference example of the step time dt when a simulation considering the influence of the Young's modulus σ is performed, using a method described in Japanese Laid-open Patent Publication No. 2014-211798 is 0.1 micro seconds or less. If a larger step time dt than this example is used, the accuracy of a simulation is drastically reduced, or results disperse and a solution may not be obtained.

On the other hand, in this embodiment in which the Young's modulus σ is considered in a pseudo manner, using the corrected viscosity μ′, the step time dt of about 1 micro second may be used. Therefore, as compared with the method described in Japanese Laid-open Patent Publication No. 2014-211798, in this embodiment, a simulation with an equal level of accuracy may be performed with a calculation amount of one tenth or less.

A simulation program may be executed by a large computer coupled to the communication unit 15 via a network (not illustrated). The physical property DB 31 and the particle DB 32 may be stored in a server coupled to the communication unit 15 via a network (not illustrated).

A target that is simulated is not limited to a flow process and a solidifying process of molten metal. A simulation device according to this embodiment may be used for analyzing a material, that is, a viscoelastic body, which has viscosity and elasticity.

### Second Embodiment

This embodiment is related to a method for generating the physical property DB 31. Note that the description of each part that is in common with the first embodiment will be omitted.

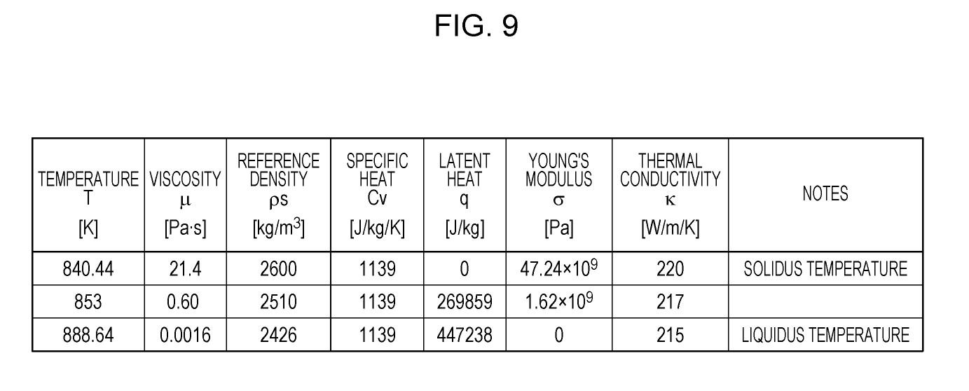

FIG. 9 is a table illustrating a record layout of a basic physical property DB according to a second embodiment. The basic physical property DB is a DB that associates the absolute temperature and physical property of a material with one another. The basic physical property DB includes a temperature T field, a viscosity μ field, a reference density ρs field, a specific heat Cv field, a latent heat q field, a Young's modulus σ field, a thermal conductivity κ field, and a notes field. The basic physical property DB includes a single record for a single temperature. Basic physical property records are arranged in an ascending order in which values were recorded in the temperature T field. The basic physical property DB is stored in the auxiliary storage device 14.

In the temperature T field, the temperature T is recorded. The unit of the temperature T is Kelvin. In the viscosity μ field, the viscosity μ corresponding to the temperature T is recorded. In the reference density ρs field, the reference density ρs of a material, corresponding to the temperature T is recorded. In the specific heat Cv field, the specific heat Cv corresponding to the temperature T is recorded. In the latent heat q field, the latent heat q corresponding to the temperature T is recorded. In the Young's modulus σ field, the Young's modulus σ corresponding to the temperature T is recorded. In the thermal conductivity κ field, the thermal conductivity κ corresponding to the temperature T is recorded. In the notes field, notes are recorded.

Each physical property recorded in the basic physical property DB is a basic physical property of a material and is data that is used in another simulation in many cases. A program according to this embodiment is a program used for generating the physical property DB 31 that is employed in the first embodiment, using the basic physical property DB.

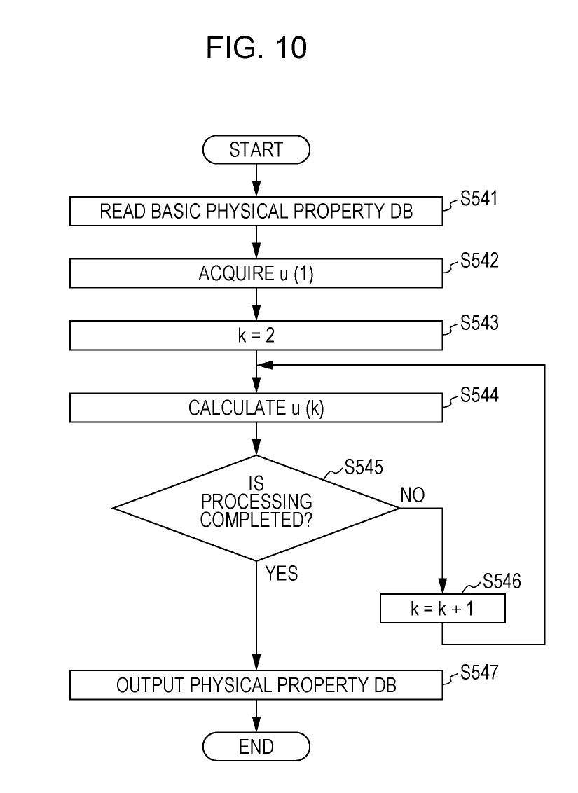

FIG. 10 is a flow chart illustrating a flow of processing of a program according to the second embodiment. A flow of processing of a program according to this embodiment will be described with reference to FIG. 10.

The CPU 12 reads the basic physical property DB, which has been described with reference to FIG. 9 (Step S541). The CPU 12 acquires the value u (1) of the internal energy u corresponding to a first record from the auxiliary storage device 14 (Step S542). As u (1), an arbitrary constant, that is, for example, zero, may be used. As another alternative, u (1) may be set as a constant in the program according to this embodiment.

The CPU 12 sets a counter k to 2 (Step S543). The CPU 12 calculates a kth internal energy u (k) using Expression 13 (Step S544). The values included in second to fourth terms of the right side of Expression 13 are values recorded in the basic physical property DB.

$$u ( {T}_{k} ) = u ( {T}_{k - 1} ) + ( \frac{{cv}_{k} + {cv}_{k - 1}}{2} ) ( {T}_{k} - {T}_{k - 1} ) + {q}_{k} - {q}_{k - 1} \qquad ( 13 )$$

wherein u (T) is the internal energy at the temperature T,
Tₖ is the temperature of the kth record of the basic physical property DB,
cvₖ is the specific heat at the temperature Tₖ, and
qₖ is the latent heat at the temperature Tₖ.

The CPU 12 determines whether or not processing is completed for all of records that have been read in Step S541 (Step S545). If the CPU 12 has determined that processing is not completed for all of the records (NO in Step S545), the CPU 12 adds 1 to the counter k (Step S546). Thereafter, the CPU 12 causes the process to return to Step S544.

If the CPU 12 has determined that processing is completed for all of the records (YES in Step S545), the CPU 12 combines the internal energy u that has been calculated in Step S544 with each data recorded in the basic physical property DB to generate the physical property DB 31. The physical property DB 31 is the same DB as the DB, which has been described with reference to FIG. 4. The CPU 12 outputs the physical property DB 31 to the auxiliary storage device 14 (Step S547). Thereafter, the CPU 12 terminates processing.

According to this embodiment, a highly accurate simulation considering the influence of the Young's modulus σ may be performed, using a general-purpose basic physical property DB in which basic physical properties that are used also in another simulation are recorded.

The program according to this embodiment may be inserted before Step S521 of the subroutine of the first embodiment, which has been described with reference FIG. 7. In this case, only an internal energy in a temperature range that is desired for a simulation may be calculated. Also, the program according to this embodiment may be executed in advance to store the physical property DB 31 in the auxiliary storage device 14. Furthermore, the physical property DB 31 achieved by interpolating data in a temperature range which is not recorded in the basic physical property DB may be stored in the auxiliary storage device 14 in advance.

### Third Embodiment

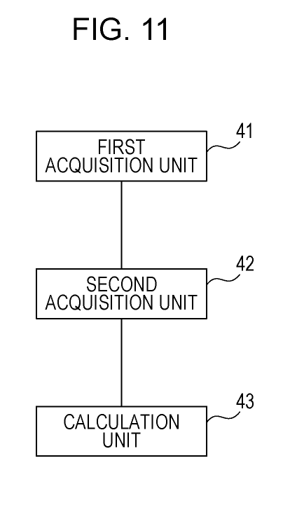

FIG. 11 is a functional block diagram illustrating an operation of a simulation device according to a third embodiment. The simulation device 10 operates in a manner described below, based on control performed by the CPU 12. A first acquisition unit 41 acquires a relationship between the viscosity and the Young's modulus of a material and the internal energy from the physical property DB 31. A second acquisition unit 42 acquires an initial value of each of the position, the density, the velocity, and the internal energy of each particle obtained by modeling a calculation target object that uses the material from the particle DB 32. A calculation unit 43 calculates the position, the density, the velocity, and the internal energy of each particle after a predetermined time has elapsed, using the corrected viscosity for the viscosity in the equation of a fluid, and records calculation results in the particle DB 32.

In this case, the equation of a fluid is an equation that indicates the relationship between the position, the density, the velocity, and the internal energy of each particle. Also, the corrected viscosity is a value obtained by correcting the viscosity associated with the internal energy that has been acquired by the second acquisition unit 42, based on the relationship that has been acquired by the first acquisition unit 41, using the Young's modulus that has been associated with the internal energy that has been acquired by the second acquisition unit 42, based on the relationship that has been acquired by the first acquisition unit 41.

### Fourth Embodiment

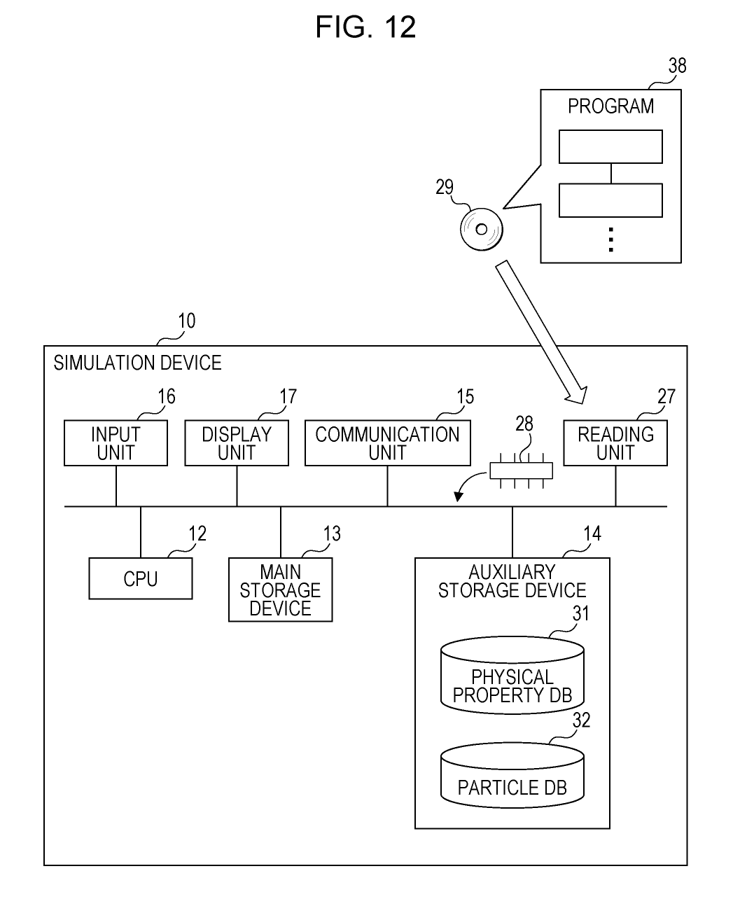

A fourth embodiment is related to an embodiment in which the simulation device 10 is realized by combining a general-purpose computer and a program 38 together and thus causing the computer and the program 38 to operate together in combination. FIG. 12 is a diagram illustrating a configuration of the simulation device 10 according to the fourth embodiment. A configuration according to this embodiment will be described with reference to FIG. 12. Note that the description of each part that is in common with the first embodiment will be omitted.

The simulation device 10 according to this embodiment includes a CPU 12, a main storage device 13, an auxiliary storage device 14, a communication unit 15, an input unit 16, a display unit 17, a reading unit 27, and a bus. The simulation device 10 is an information processing device, such as a general-purpose personal computer, and the like.

The program 38 is recorded in a portable recording medium 29. The CPU 12 reads the program 38 via the reading unit 27, and stores the program 38 in the auxiliary storage device 14. Also, the CPU 12 may read the program 38 stored in a semiconductor memory 28, such as a flash memory and the like, which is mounted in the simulation device 10. Furthermore, the CPU 12 may download the program 38 from another server computer (not illustrated) coupled via the communication unit 15 and a network (not illustrate), and thus, store the program 38 in the auxiliary storage device 14.

The program 38 is installed as a control program of the simulation device 10, is loaded in the main storage device 13, and thus, is executed. Thus, the information processing device functions as the simulation device 10 described above.

Technical features (components) described in each of the above-described embodiments may be combined with one another, and such combination makes it possible to form a new technical feature.

The embodiments disclosed herein are provided merely for illustrative purpose in every respect and are not intended to be limiting in any aspect. The scope of the present disclosure is defined by the scope of claims rather than the above-described description, and is intended to include any modifications within the scope and meaning equivalent to the terms of the claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A simulation device comprising a processor and a memory coupled to the processor, the processor executes a process comprising:
a first acquiring a relationship among a viscosity, a Young's modulus and an internal energy of a material;
a second acquiring an initial value of each of a position, a density, a velocity, and an internal energy of each particle obtained by modeling a simulation target object that uses the material; and
a first calculating the position, the density, the velocity, and the internal energy of the each particle after a predetermined time has elapsed, based on a corrected viscosity obtained by correcting the viscosity using the internal energy acquired by the second acquiring and the viscosity and Young's modulus acquired using the relationship acquired by the first acquiring.

2. The simulation device according to claim 1,
wherein
the corrected viscosity is determined by adding the product of the Young's modulus and a constant to the viscosity.

3. The simulation device according to claim 1,
wherein
the corrected viscosity is determined, based on Expression 14 below.
$$μ ( u ) + σ ( u ) \times \frac{A}{{C}_{0}} \qquad ( 14 )$$
where μ (u) is the viscosity of the material when the internal energy is u,
σ (u) is the Young's modulus of the material when the internal energy is u,
A is the diameter of the particle, and
C₀ is a predetermined constant.

4. The simulation device according to claim 1,
wherein the first acquiring further comprising
a third acquiring the viscosity, the Young's modulus, a specific heat, and a latent heat of the material at a plurality of temperatures,
a fourth acquiring an internal energy of the material at a first temperature among the plurality of temperatures, and
a second calculating an internal energy at each of the plurality of temperature, based on a relationship between changes of the internal energy, the temperature, the specific heat, and the latent heat of the material, from the temperature among the plurality of temperatures, the specific heat, and the latent that have been acquired by the third acquiring and the internal energy that has been acquired by the fourth acquiring.

5. A non-transitory simulation program for causing a computer to execute a process, the process comprising:
acquiring a relationship between a viscosity and a Young's modulus of a material and an internal energy;
acquiring an initial value of each of a position, a density, a velocity, and an internal energy of each particle obtained by modeling a calculation target object that uses the material; and
calculating the position, the density, the velocity, and the internal energy of the each particle after a predetermined time has elapsed, based on a corrected viscosity obtained by correcting the viscosity using the acquired internal energy and the viscosity and the Young's modulus acquired using the acquired relationship.

6. A simulation method for causing a computer to execute a process, the process comprising:
causing the computer to acquire a relationship between a viscosity and a Young's modulus of a material and internal energy;
causing the computer to acquire an initial value of each of a position, a density, a velocity, and an internal energy of each particle obtained by modeling a calculation target that uses the material; and
calculating the position, the density, the velocity, and the internal energy of the each particle after a predetermined time has elapsed, based on a corrected viscosity obtained by correcting the viscosity using the acquired internal energy and the viscosity and Young's modulus acquired using the acquired relationship.
